(19) United States
(12) Patent Application Publication
(10) Pub. No.: US 2009/0129098 A1
(43) Pub. Date: May 21, 2009

(54) LIGHT GUIDE PLATE HAVING MULTI-FACET REFLECTION STRUCTURE

(76) Inventors: Yi-Fang Lin, Kaohsiung (TW); Yong-Zhi Wang, Kaohsiung (TW); Mitsuo Araya, Kaohsiung (TW); Ying-Fu Wang, Kaohsiung (TW)

Correspondence Address: LEONG C LEI, PMB # 1008, 1867 YGNACIO VALLEY ROAD, WALNUT CREEK, CA, 94598, US

(21) Appl. No.: 11/941,987

(22) Filed: Nov. 19, 2007

(51) Int. Cl. F21V 7/00

(52) U.S. Cl. 362/346

(57) ABSTRACT

The light guide plate has a flat body. At least one of the light emission plane and the light reflection plane of the light guide plate has a number of linear reflection structures arranged in parallel along the surface. The reflection structures have a V-shaped cross section pointing outward from or inward into the surface. Each reflection structure further has at least one of its end surfaces slanting towards the other end. It is the reflection structures' slant end surfaces that provide additional collimation and enhancement to the light beams traveling through the light guide plate.

### (a) TECHNICAL FIELD OF THE INVENTION

The present invention generally relates to light guide plates, and more particularly to a light guide plate having multi-facet reflection structures arranged along at least one of the light emission plane and the light reflection plane of the light guide plate.

### (b) DESCRIPTION OF THE PRIOR ART

Light guide plate is one of the most important components in a backlight module of a liquid crystal display (LCD) device. The major function of the light guide plate is to direct the light beams from a light source of the backlight module to the panel of the LCD device.

As shown in FIG. 1, a light guide plate 1 has a light emission plane 11, a light reflection plane 12 opposite to the light emission plane 11, and a light incidence plane 13 between the light emission plane 11 and the light reflection plane 12.

The light beams emanated from a light source A enter the light guide plate 1 via the light incidence plane 13. The light beams hitting the light reflection plane 12 are reflected and redirected towards the light emission plane 11 where the light beams leave the light guide plate 1.

To achieve a better optical property from the light beams, at least one of the light emission plane 11 and the light reflection plane 12 are provided with a number of linear reflection structures 14 aligned in parallel along the surface. The reflection structures 14 have a V-shaped cross section either pointing outward away from or inward into the light guide plate 1. The slant surfaces along the length of the reflection structures 14 not only redirect the light beams towards the panel of the LCD device but also collimate the light beams so as to achieve enhanced brightness.

The foregoing V-shaped reflection structures have already been widely adopted by light guide plate manufacturers. To achieve better performance, quite a few variations such as altering the distance between the reflection structures 14, the density of the reflection structures 14, and the angles of the slant surfaces of the reflection structures 14 are proposed. However, these endeavors can only achieve limited improvements.

### SUMMARY OF THE INVENTION

Accordingly, a novel light guide plate is provided herein whose purpose is to achieve greater treatment and thereby brightness enhancement to the incident light beams than the conventional light guide plates.

According to the present invention, at least one of the light emission plane and the light reflection plane of the light guide plate has a number of linear reflection structures arranged in parallel along the surface. The reflection structures have a V-shaped cross section pointing outward from or inward into the surface. Each reflection structure further has at least one of its end surfaces slanting towards the other end. It is the reflection structures' slant end surfaces that provide additional collimation and enhancement to the light beams traveling through the light guide plate.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a conventional light guide plate.

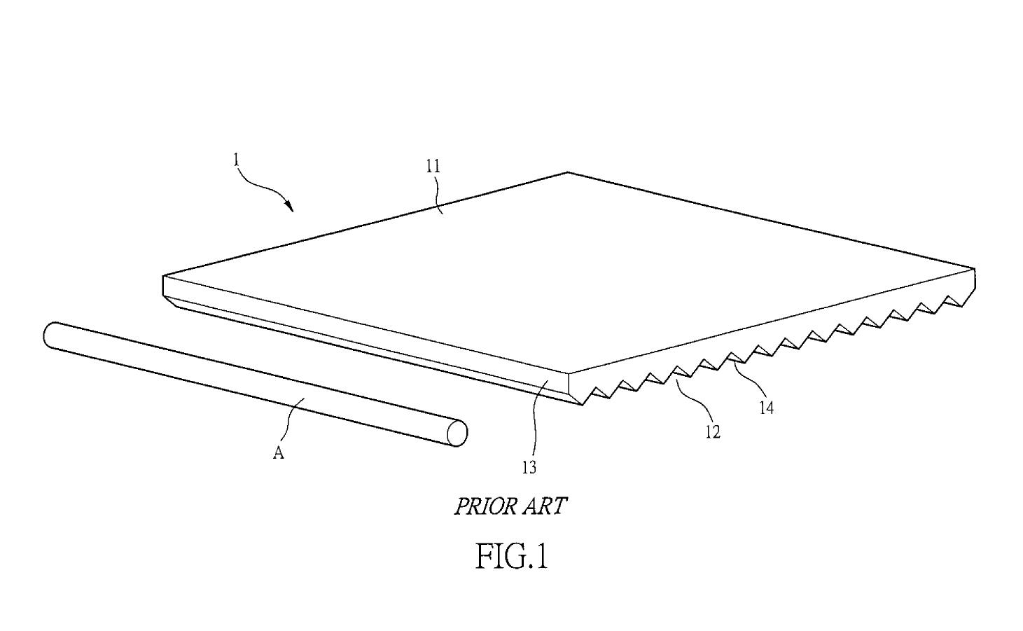

FIG. 2 is a perspective view showing a light guide plate according to a first embodiment of the present invention.

FIG. 3 is perspective view showing a light guide plate according to a second embodiment of the present invention.

FIG. 4 is a perspective view showing a light guide plate according to a third embodiment of the present invention.

FIG. 5 is a perspective view showing a light guide plate according to a fourth embodiment of the present invention.

FIG. 6 is a perspective view showing a light guide plate according to a fifth embodiment of the present invention.

FIG. 7 is a planar view showing a light guide plate according to a sixth embodiment of the present invention.

FIG. 8 is a planar view showing a light guide plate according to a seventh embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

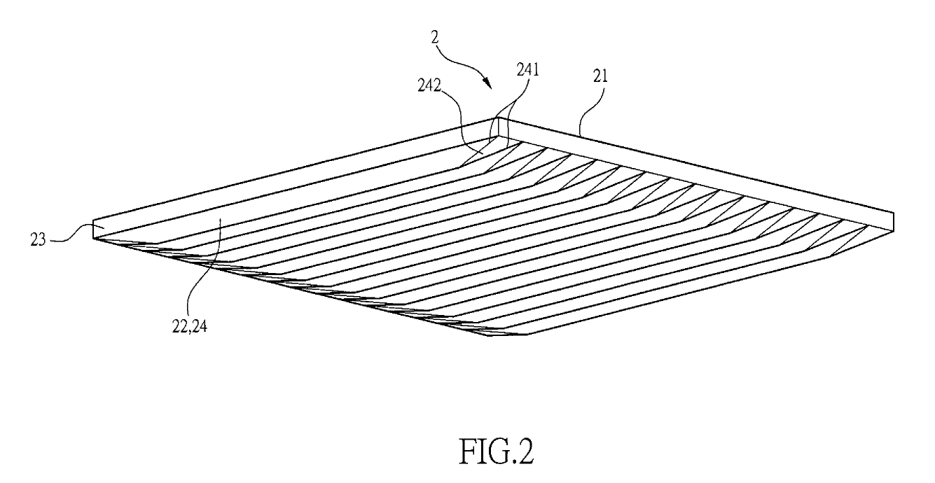

As shown in FIG. 2, a light guide plate 2 according to a first embodiment of the present invention has a flat body made of a material having a substantial transparency with a light emission plane 21, a light reflection plane 22 opposite to the light emission plane 21, and a light incidence plane 23 located between the light emission plane 21 and light reflection plane 22. A number of linear reflection structures 24 are arranged in parallel along at least one of the light emission plane 21 and the light reflection plane 22. In this embodiment, the reflection structures 24 are on the light reflection plane 22 only. The reflection structures 24 have a V-shaped cross section pointing outward from or inward into the light emission plane 21 and/or the light reflection plane 22. Each V-shaped reflection structure 24 is formed by two slant side surfaces 241 along the length of the reflection structures 24. For a reflection structure 24, its two slant side surfaces 241 could have identical or different angles to the light guide plate 2 (or, more specifically, to the surface where the reflection structure 24 is located). Furthermore, at least an end of a reflection structure 24 has its V-shaped end surface 242 slanted toward the other end.

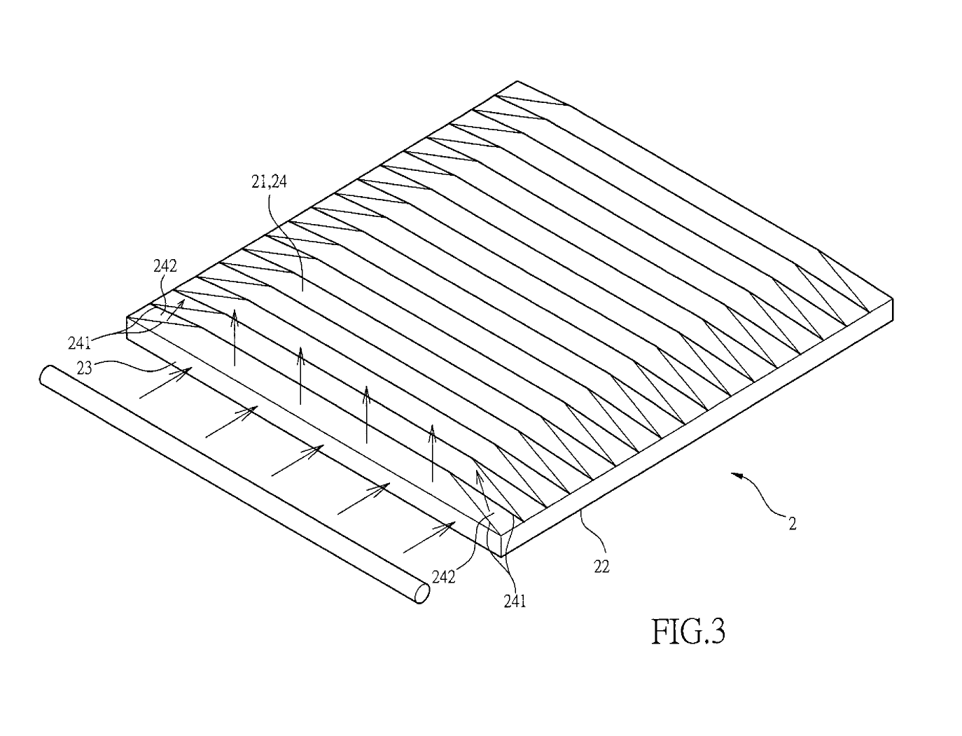

FIG. 3 shows a second embodiment of the present invention where the reflection structures 24 protrude from the light emission plane 21. As illustrated, a linear light source (not numbered) is positioned parallel to the light incidence plane 23 and the emanated light beams enter the light guide plate 2 via the light incidence plane 23. When the light beams hit the slant surfaces 241 of the reflection structures 24, they are reflected and redirected towards the light emission plane 21. In addition, the slant end surfaces 242 cause the light beams to travel towards the other ends of the reflection structures 24 and, thereby, increase the light emission efficiency of the light guide plate 2.

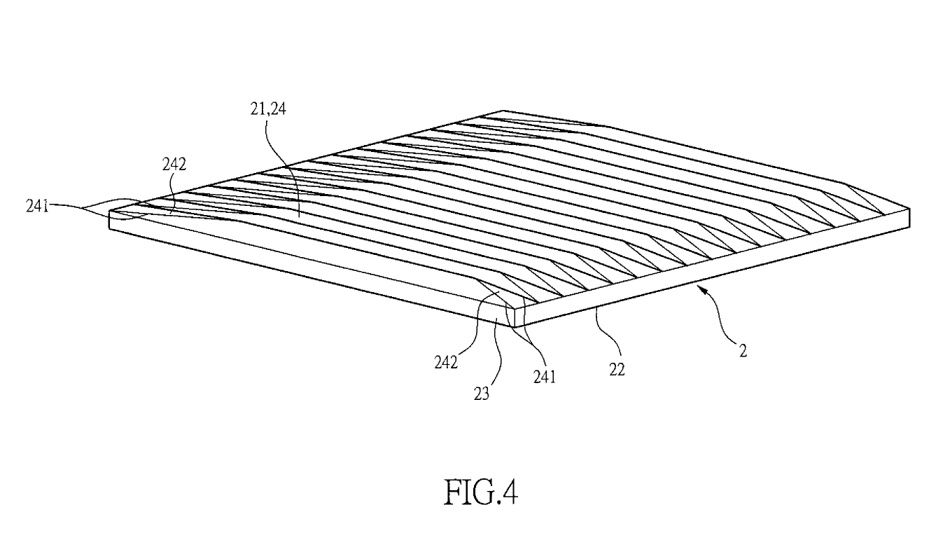

As shown in FIG. 4, which illustrates a third embodiment of the present invention, each reflection structure 24 has slant end surfaces 242 at both ends. In the present embodiment, one end surface 242 slants more heavily towards the other end and therefore has a larger surface area than the other end surface 242. As such, the two end surfaces 242 provide different treatments to the incident light beams and the light guide plate 2 therefore can provide adjustment to a specific light source.

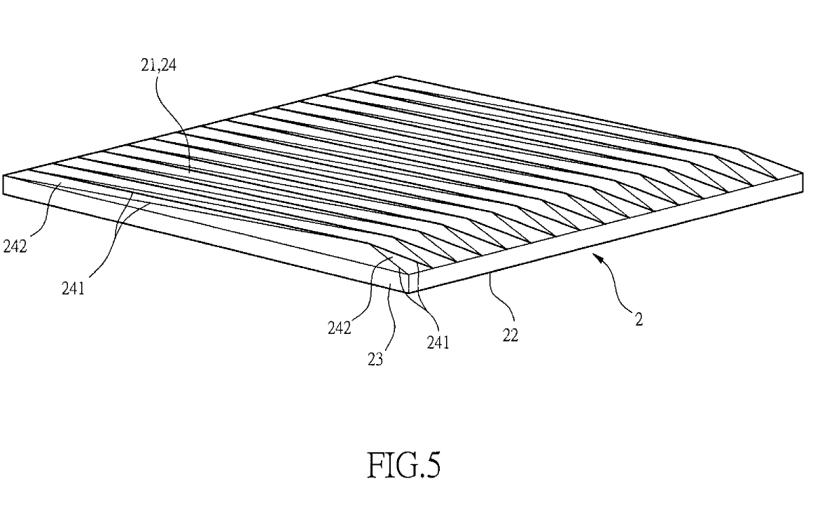

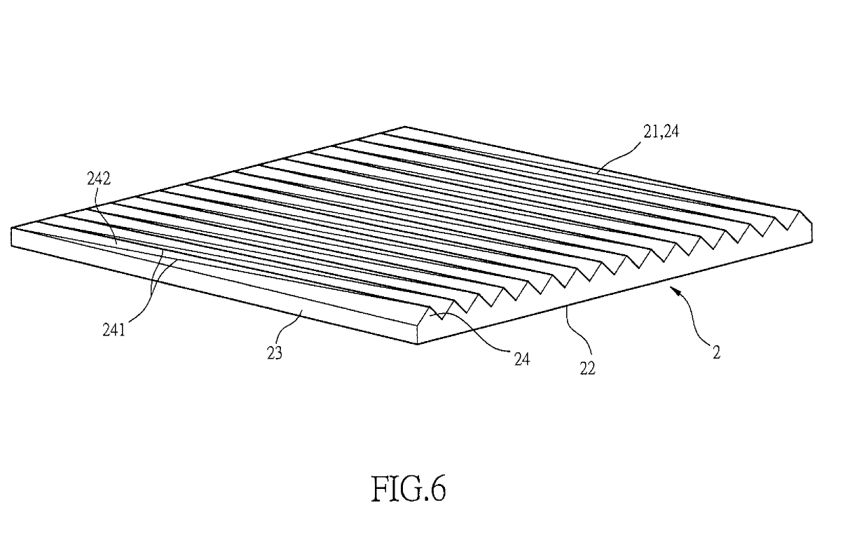

In FIG. 5, which illustrates a fourth embodiment of the present invention, each reflection structure 24 also has slant end surfaces 242 at both ends and one end surface 242 slants more heavily towards the other end so that the vertices of the two end surfaces 242 meet together. Similarly, in FIG. 6, which shows a fifth embodiment of the present invention, the two end surfaces 242 of each reflection structure 24 also meet together. However, one of the end surfaces 242 is actually perpendicular to the light emission plane 21 (i.e., a vertical end surface). In other words, the slant end surface 242 is extended completely across the light emission plane 21 to reach the vertical end surface 242. As such, the two end surfaces 242 provide more dramatically different treatments to the incident light beams.

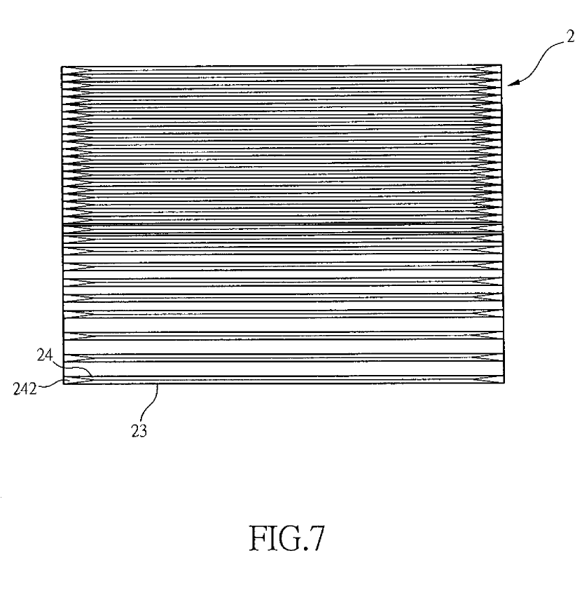

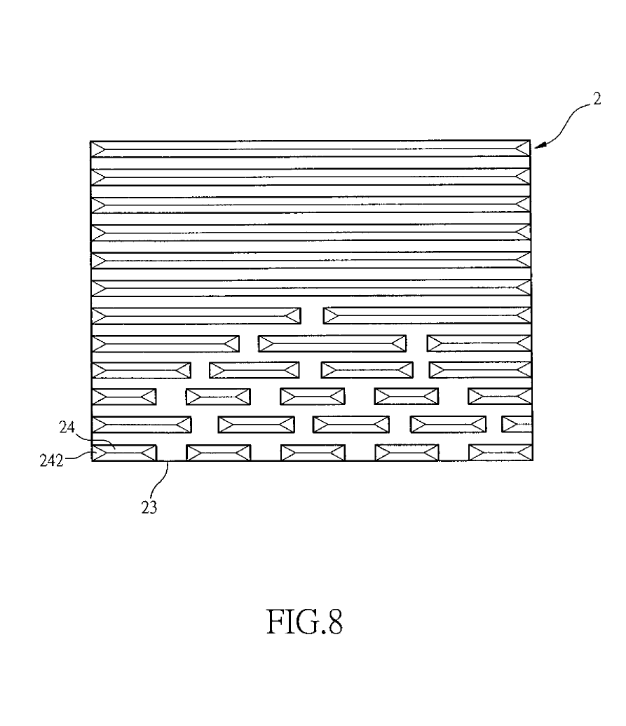

FIG. 7 shows a sixth embodiment of the present invention where the density of the reflection structures 24 is different in accordance with the distance to the light incidence plane 23 or the light source. As the light beams attenuate as they travel deeper into the light guide plate 2, to compensate for such difference, the reflection structures 24 can be more densely (or sparsely) arranged as they are more distant from (or adjacent to) the light incidence plane 23. Additionally, as shown in FIG. 8, instead of always having the reflection structures 24 laid out from one side of the light guide plate 2 to the other side, the reflection structures 24 could have different lengths. As illustrated, in a section of the light emission plane 21, there are more reflection structures 24 of shorter lengths aligned in parallel. More reflection structures 24 imply that there are more slant end surfaces 242, which in turn implies that greater compensation and alternation to the light beams can be achieved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light guide plate, comprising:
a flat body having a light emission plane, a light reflection plane opposite to said light emission plane, and at least a light incidence plane between said light emission plane and said light reflection plane where light beams from a light source enter said light guide plate; and
a plurality of linear reflection structures having a V-shaped cross section aligned in parallel along at least one of said light emission plane and said light reflection plane, each reflection structure having two slant side surfaces along the length of said reflection structure forming said V-shaped cross section, at least an end of a reflection structure having an end surface slanting towards the other end of said reflection structure.

2. The light guide plate according to claim 1, wherein said V-shaped reflection structures point outward from said light guide plate.

3. The light guide plate according to claim 1, wherein said slant side surfaces of a reflection structure have different angles to said light guide plate.

4. The light guide plate according to claim 1, wherein a reflection structure has both of its end surfaces slanting towards the other end; and said end surfaces have different angles to said light guide plate.

5. The light guide plate according to claim 1, wherein a reflection structure has an end surface slanting towards the other end and the other end surface perpendicular to said light guide plate; and said slant end surface is extended to contact the other end surface.

6. The light guide plate according to claim 1, wherein said reflection structures are more densely arranged where said reflection structures are more distant from said light incidence plane.

7. The light guide plate according to claim 1, wherein said reflection structures have different lengths; and shorter reflection structures are more densely arranged than where longer reflection structures are arranged.
